(19) United States
(12) Patent Application Publication
(10) Pub. No.: US 2007/0028027 A1
(43) Pub. Date: Feb. 1, 2007

(54) Memory device and method having separate write data and read data buses

(75) Inventors: Jeff Janzen, Meridian, ID (US); Jeffrey Wright, Boise, ID (US); James Cullum, Boise, ID (US)

Correspondence Address: Edward W. Bulchis, Esq.;DORSEY & WHITNEY LLP, Suite 3400, 1420 Fifth Avenue, Seattle, WA, 98101, US

(73) Assignee: MICRON TECHNOLOGY, INC.

(21) Appl. No.: 11/190,370

(22) Filed: Jul. 26, 2005

(51) Int. Cl. G06F 12/06; G06F 12/00

(52) U.S. Cl. 711/5; 711/105

(57) ABSTRACT

A synchronous dynamic random access memory (“SDRAM”) device includes several banks of memory cell coupled to a read data path and a write data path. The read data path includes a read latch that stores a relatively large number of read data bits received in parallel from a bank of memory cells. Groups of the stored read data bits are sequentially selected by a multiplexer and applied to a read data bus. Groups of write data bits are sequentially coupled to the SDRAM device through a write data bus that is separate from the read data bus, and they are sequentially stored in input registers. When the input registers are full, the write data bits are coupled in parallel to a bank of memory cells. The number of bits in the write data bus is preferably a submultiple of the number of bits in the read data bus.

### TECHNICAL FIELD

This invention relates to memory devices, and, more particularly, to a memory device having separate unidirectional write and read data buses.

### BACKGROUND OF THE INVENTION

Memory devices are commonly used in a wide variety of electronic devices, such as personal computers. A memory device 10, such as a dynamic random access memory (“DRAM”) device, a static random access memory (“SRAM”) device, a flash memory device, or another type of memory device, is shown in FIG. 1. The memory device 10 includes a set of command terminals 14, which is typically connected to a command bus 16, a set of address terminals 20, which is typically connected to an address bus 24, and a set of data terminals 26, and which is typically the connected to a data bus 28. The command bus 16 and the address bus 24 are unidirectional buses while the data buses 28 is a bidirectional bus.

In operation, command signals corresponding to a memory command, such as a read or a write command, are coupled through the command bus 16 to the command terminals 14. In response, the memory device 10 performs an operation corresponding to the memory command. Address signals corresponding to a storage location in the memory device 10 are coupled through the address bus 24 to the address terminals 20. The address signals are often in the form of two different groups of signals corresponding to row and column addresses. The address specifies the storage location in the memory device where the operation corresponding to the memory command used to occur. For example, in the case of a write command, data coupled to the data terminals 26 through the data bus 28 are written to the storage location in the memory device 10 corresponding to the address coupled through the address bus 24. In the case of a read command, data read from the storage location in the memory device 10 corresponding to the address are coupled from the data terminals 26 through the data bus 28.

A high data bandwidth is a desirable capability of memory systems. Generally, bandwidth limitations are not related by memory controllers typically coupled to memory devices since the memory controllers sequence data to and from the memory devices as fast as the memory devices allow. However, memory devices have not been able to keep up with increases in the data bandwidth of memory controllers and memory data buses. In particular, the memory controller must schedule all memory commands to the memory devices in a manner that allows the memory devices to respond to the commands. Although these hardware limitations can be reduced to some degree through the design of the memory device, a compromise must be made because reducing the hardware limitations typically adds cost, power, and/or size to the memory devices, all of which are undesirable alternatives. While memory devices can rapidly handle “well-behaved” accesses at ever increasing rates, for example, sequel traffic to the same page of a memory device, it is much more difficult for the memory devices to resolve “badly-behaved traffic,” such as accesses to different pages or banks of the memory device. As a result, the increase in memory data bus bandwidth does not result in a corresponding increase in the bandwidth of the memory system.

In addition to the limited bandwidth of memory devices, the performance of computer systems is also limited by latency problems that increase the time required to read data from memory devices. More specifically, when a memory device read command is coupled to a system memory device, such as a synchronous DRAM (“SDRAM”) device, the read data cannot be output from the SDRAM device until a delay of several clock periods has occurred. Although SDRAM devices can synchronously output burst data at a high data rate, the delay in initially providing the data can significantly slow the operating speed of a computer system using such SDRAM devices. These latency issues generally cannot by alleviated to any significant extent by simply increasing the memory data bus bandwidth.

The memory latency problem is greatly exacerbated by read accesses alternating with write accesses, a situation known as “read/write turnarounds.” When a memory controller issues a read command to a memory device, the memory device must couple read data from a memory array to external data bus terminals of the memory device. The read data must then be coupled through a data bus portion of the memory bus from the memory device to the memory controller. It is only then that the memory controller can couple write data to the memory device through the data bus to initiate a write memory access.

Latency problems also exist for sequentially read command directed to different pages of memory cells in memory devices. If a second read is directed to a different page, the page to which the read is directed will not be an “open” page, i.e., a row of memory cells from which data was read during the previous memory access. If the row to which the read access is directed is not already open, data cannot be coupled from a memory array to the data bus terminals of the memory device until the page has been opened. Opening the page requires the coupling of memory command and a row address and a column address from the memory controller to the memory device. In response to the read address, the memory device must equilibrate the corresponding row, turn on access transistors for that row, and allow a sense amplifier for each column to sense the voltage that a respective memory cells couples to the sense amplifier. All of this can take a considerable period of time. For this reason, read operations from a closed page and read/write turnarounds can prevent memory devices from even coming close to achieving the data bandwidths that are possible with high speed memory controllers and memory buses.

The above-described problems are to some extent the result of using a single bidirectional data bus 28 for coupling write data signals to and read data signals from the memory device 10. More specifically, since read data signals and write data signals cannot simultaneously be present on the data bus 28, the use of a single data bus 28 prevents data from being written to the memory device 10 at the same time that data are being read from the memory device 10. In fact, a memory controller (not shown) or other device coupled to the memory device 10 through the data bus 28 generally cannot apply write data to the data bus 28 during the period that the memory device 10 is processing a read command and is preparing to output read data from the memory device 10.

The limitations of conventional memory devices using a bidirectional data bus can be addressed in memory devices, such as the memory device 30 shown in FIG. 2. The memory device 30, like the memory device 10, includes command terminals 14 coupled to the command bus 16 and address terminals 20 coupled to the address bus 24. However, unlike the memory device 10, the memory device 30 includes a set of write data terminals 34 coupled to a unidirectional write data bus 38, and a set of a read data terminals 40 coupled to a unidirectional read data bus 42. In operation, a predetermined number of write data signals are coupled to the memory device 30 through the write data bus 38, and the same number of read data signals are coupled from the memory device 30 through the read data bus 42.

The use of a separate write data bus 38 to couple write data signals to the memory device 30 and a separate read data bus 42 to couple read data signals from the memory device 30 can provide significant performance advantages compared to the memory device 10 shown in FIG. 1. For example, the use of separate write and read data buses 38, 42, respectively, can allow the memory device 30 to receive write data at the same time that the memory device 30 is transmitting read data. As a result, the data bandwidth of the memory device 30 can be significantly higher than the data bandwidth of the memory device 10 shown in FIG. 1.

Although the use of separate write and read data buses 38, 42, respectively, does provide performance advantages, these advantages are accompanied by some disadvantages. In particular, the use of separate write and read data buses 38, 42 can undesirably increase the number of terminals in the memory device 30. As is well known the art, the area that can be occupied by terminals is limited by the size of the package containing the memory device 30. While the size of the package could be increased to accommodate a large number of data bus terminals, doing so would make electronic devices containing the memory device 30 less compact. Another disadvantage of using separate write and read data buses is the space occupied by the read data bus and write data bus conductors on a printed circuit board or other substrate on which the memory device 30 is mounted.

There is therefore a need for a memory device that can allow write data to be coupled to the memory device at the same time that read data can be coupled from the memory device without the disadvantages associated with memory devices using separate read and write data buses.

### SUMMARY OF THE INVENTION

A memory device and method according to the present invention uses a write data bus and a separate read data bus having a width that is different from the width of the write data bus. The memory device and method preferably includes means for properly address mapping the write data to the read data so that the storage locations accessed in the memory device at an address for a read operation are the same as the storage locations accessed in the memory device at the address for a write operation. For example, the memory device may include a read data path that includes a relatively wide read latch that is loaded by parallel read data bits received from an array of memory cells. Groups of the read data bits are then output from the memory device in sequence in a burst manner. The memory device may also include a write data path that includes input registers that are sequentially loaded by groups of write data bits applied to the memory device in a burst manner. When the input registers have been loaded by the groups of write data bits, the data stored in the input registers may be applied to the array of memory cells in parallel. The product of the number of bits stored in the read latch and number of bits in each burst of read data is preferably the same as the product of the number of bits loaded into the input registers and number of bits in each burst of write data. As a result, the number of write data bits applied to the memory device with each burst of write data is equal to the number of read data bits output from the memory device with each burst of read data.

### BRIEF DESCRIPTION OF THE DRAWINGS

FIG. 1 is a block diagram of one example of a conventional memory device.

FIG. 2 is a block diagram although another example of a conventional memory device.

FIG. 3 is a block diagram of a memory device according to one example of the invention.

FIG. 4 is a detailed block diagram of one example of the memory device of FIG. 3.

FIG. 5 is a schematic diagram showing one example of how write data can be mapped to read data in memory devices according to various example of the invention.

FIG. 6 is a timing diagram showing an example of the operation of the memory device of FIG. 4 when performing a basic read operation.

FIG. 7 is a timing diagram showing an example of the operation of the memory device of FIG. 4 when performing a basic write operation.

FIG. 8 is a timing diagram showing an example of the operation of the memory device of FIG. 4 when performing a sequential write and read operations directed to the same bank of memory cell arrays.

FIG. 9 is a timing diagram showing an example of the operation of the memory device of FIG. 4 when performing a sequential write and read operations directed to the different banks of memory cell arrays.

FIG. 10 is a block diagram showing one example of a technique that can be used to couple write data bits to arrays of memory cells in a memory device according to one example of the invention.

FIG. 11 is a block diagram of one example of a computer system using the memory device of FIG. 4.

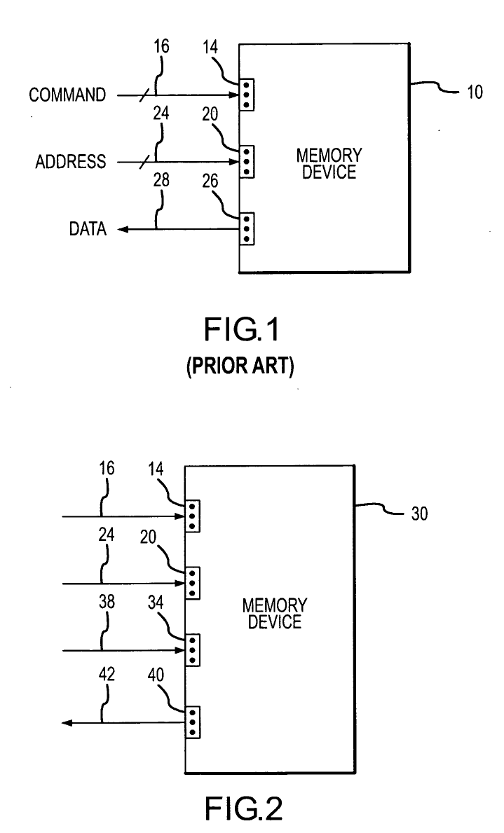

### DETAILED DESCRIPTION OF THE INVENTION

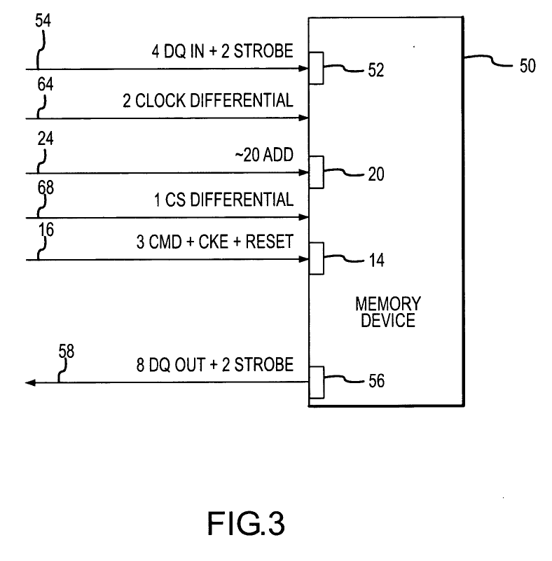

A memory device 50 according to one embodiment of the invention is shown in FIG. 3. The memory device 50 may be a DRAM device, and SRAM device, a ROM device, a flash memory device, or some other type of memory device. The memory device 50, like the memory devices 10, 30, includes a set of command terminals 14 coupled to a command bus 16, In the example shown in FIG. 3, the command bus 16 has a width of five bits for coupling 3 command bits, a clock enable (“CKE”) signal, and a reset signal to the memory device 50. The memory device 50 also includes a set of address terminals 20 coupled to an address bus 24. The memory device 50, like the memory device 30, includes a set of write data terminals 52 coupled to a write data bus 54 and a set of read data terminals 56 coupled to a read data bus 58. However, unlike the write data bus 38 and read data bus 42 coupled to the memory device 30 as shown in FIG. 2, the width of the write data bus 54 is not the same as the width of the read data bus 58. In most cases, the width of the read data bus 58 will be substantially greater than the width of the write data bus 54 because the amount of read data coupled from a memory device is generally greater than the amount of write data coupled to the memory device. By using a reduced width write data bus 54, the number of data bus terminals 52, 56 can be reduced. Although the reduced width of the write data bus 54 does, in theory, reduce the data bandwidth of the memory device 50, in practice the reduction in the data bandwidth is relatively small. The reason the reduction in data bandwidth is relatively small is primarily because, as mentioned above, there is generally a lesser amount of data being written to the memory device 50 compared to the amount of data being read from the memory device 50. Although the ratio of the width of the read data bus 58 to the width of the write data bus 54 can be varied as desired, in the memory device 50 shown in FIG. 3, the width of the read data bus 58 is twice the width of the write data bus 54. For example, the write data bus 54 may have a width of 4 bits, and the read data bus 58 may have a width of 8 bits. The read data bus 58 includes two complementary read data strobe signals, and the write data bus 54 includes two complementary write data strobe signals. Also included are a pair of signal lines 64 through which complementary clock signals are coupled to the memory device 50, and a signal line 68 through which a “chip select” signal is applied to the memory device 50.

In operation, data are transferred to and from the memory device 50 with 8-byte transfers, which equates to read data being coupled through the read data bus 58 with a burst length of 8, and write data being coupled through the write data bus 54 with a burst length of 16. As explained in greater detail below, means are provided for aligning the different read and write burst lengths so that the data written to the memory device 50 can be properly read. The memory device 50 preferably has an architecture that allows write data coupled through the write data bus 54 to be written to one bank of memory cells while read data read from a different bank of memory cells are being coupled through the read data bus 56. Although the frequency of the write data strobe signals is preferably the same as the frequency of the read data strobe signals, in some embodiments the frequency of the write data strobe signals may be twice the frequency of the read data strobe signals. Under these circumstances, the write data bandwidth is identical to the read data bandwidth. The rate at which write data and read data are internally coupled in the memory device 50 may also be varied as desired.

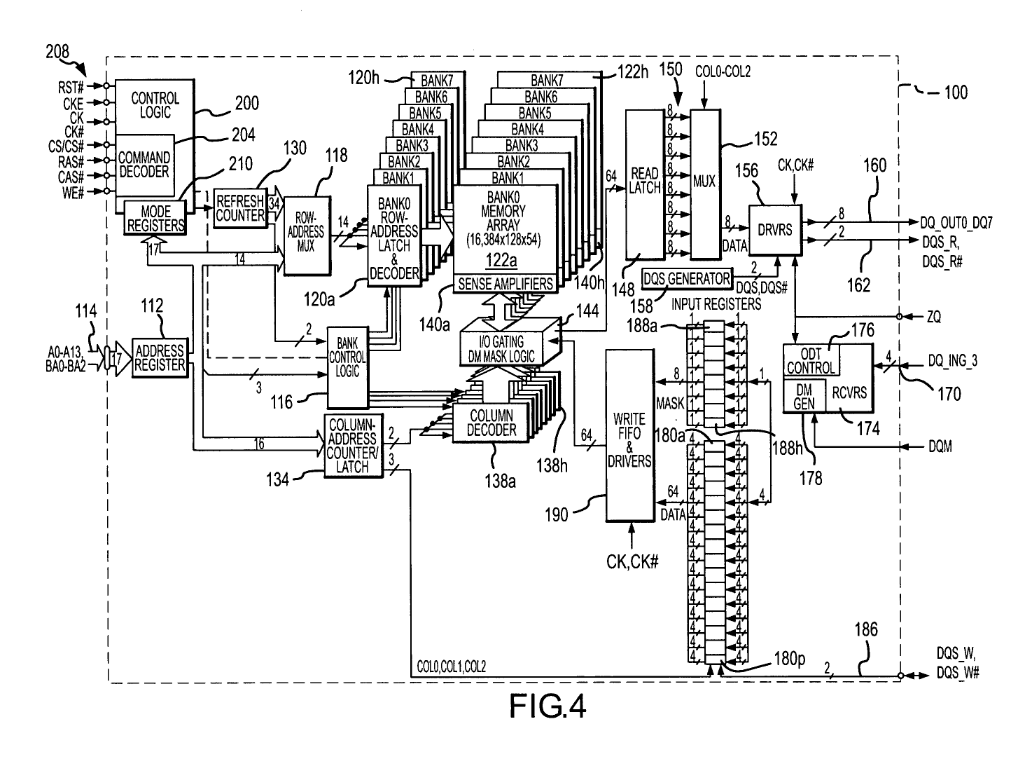

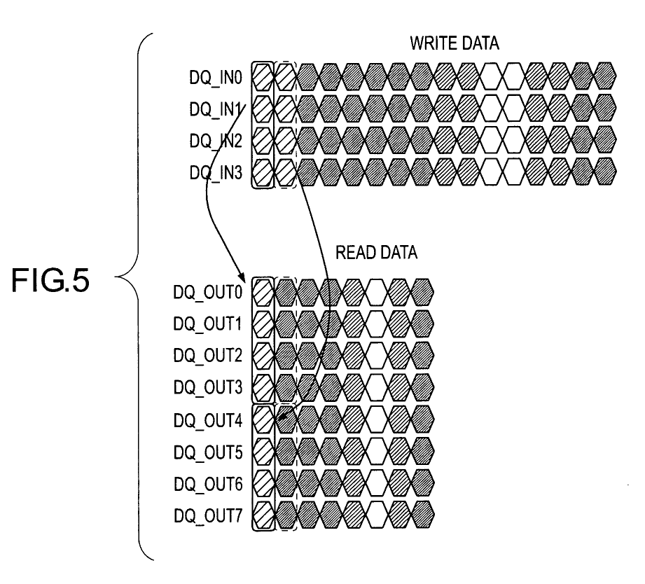

A synchronous dynamic random access (“SDRAM”) device 100 according to one embodiment of the invention is shown in FIG. 4. The SDRAM device 100 includes an address register 112 that receives bank addresses, row addresses and column addresses on an address bus 114. The address bus 114 is generally coupled to a memory controller (not shown in FIG. 4). A 3-bit bank address is received by the address register 112 and is coupled to bank control logic 116 that generates bank control signals, which are described further below. The bank address is normally coupled to the SDRAM device 100 along with a row address. The row address is received by the address register 112 and applied to a row address multiplexer 118. The row address multiplexer 118 couples the row address to row address latch & decoder circuit 120a-h for each of eight banks of memory cell arrays 122a-h, respectively.

One of the latch & decoder circuits 120a-h is enabled by a control signal from the bank control logic 116 depending on which bank of memory cell arrays 122a-h is selected by the bank address. The selected latch & decoder circuit 120 applies various signals to its respective bank of memory cell arrays 122 as a function of the row address stored in the latch & decoder circuit 120. These signals include word line voltages that activate respective rows of memory cells in the arrays 122a-h.

The row address multiplexer 118 also couples row addresses to the row address latch & decoder circuits 120a-h for the purpose of refreshing the memory cells in the arrays 122a-h. The row addresses are generated for refresh purposes by a refresh counter 130. During operation, the refresh counter 130 periodically increments to output row addresses for rows in the array 122a-h.

After the bank and row addresses have been applied to the address register 112, a column address is applied to the address register 112. The address register 112 couples the column address to a column address counter/latch circuit 134. The counter/latch circuit 134 stores the column address, and, when operating in a burst mode, generates column addresses that increment from the received column address. In either case, either the stored column address or incrementally increasing column addresses are coupled to column address decoders 138a-h for the respective banks of memory cells arrays 122a-h. The column address decoders 138a-h apply various signals to respective sense amplifiers 140a-h through an I/O gating and mask logic circuit 144. The I/O gating and mask logic circuit 144 includes conventional I/O gating circuits, data mask logic, read data latches for storing read data from the memory cells in the arrays 122a-h and write drivers for coupling write data to the memory cells in the arrays 122a-h.

Data read from one of the banks of memory cell arrays 122a-h are sensed by a respective set of sense amplifiers 140a-h and then coupled through the I/O gating and mask logic circuit 144 to a read latch 148. In the SDRAM device 100 shown in FIG. 4, 64 bits of read data are coupled to the read latch 148, although different numbers of read data bits may be coupled to the read latch 148. The read latch 148 stores the read and outputs the stored read data in groups of 8 bits on respective buses 150. Each of the buses 150 is sequentially selected by a multiplexer 152, which is controlled by the three least significant bits of the column address, COL0-COL2. The byte of data currently being selected by the multiplexer 152 is coupled to a read data driver 156, which also receives complementary read data strobe signals DQS, DQS# from a DQS generator 158. The read data driver 156 applies the 8 bits of stored read data bits to an 8-bit read data bus 160 responsive to complementary clock signals CK, CK#. The data strobe signals DQS, DQS# are used by the read data driver 156 to apply read data strobe signals DQS_R, DQS_R# to respective read data strobe lines 162 responsive to the complementary clock signals CK, CK#. The read data driver 156 outputs the read data bits and the read data strobe signals DQS_R, DQS_R# with an output impedance that is controlled by an impedance control signal ZQ.

Data to be written to the banks of memory cell arrays 122a-h are coupled from a 4-bit write data bus 170 to a write data receiver circuit 174, which includes an on-die termination (“ODT”) circuit 176. The ODT circuit 176 controls the input impedance of the receiver circuit 174 responsive to the impedance control signal ZQ. The write data receiver circuit 174 also includes a data mask circuit 178 that can generate a mask data bit responsive to a data mask signal DQM. The 4 bits of write data being applied to the write data receiver circuit 174 from the bus 170 are applied to each of sixteen input registers 180a-p. One of the input registers 180a-p that is selected by the three least significant bits of the column address, COL0-COL2 stores the 4 write data bits from the receiver circuit 174 responsive to the complementary write data strobe signals DQS_W, DQS_W#, which are coupled through a pair of signal lines 186. Similarly, a mask data bit from the data mask circuit 178 is applied to each of eight data mask registers 188a-h. One of the registers 188a-p that is selected by the three least significant bits of the column address, COL0-COL2 stores the mask data bit from the data mask circuit 178 responsive to the complementary write data strobe signals DQS_W, DQS_W#.

After sixteen 4-bit groups of write data have been stored in the respective input registers 180a-p, the stored 64 bits of write data and the 8 mask bits stored in the data mask registers 188a-h are applied to a write FIFO and driver circuit 190 responsive to the complementary clock signals CK, CK#. The circuit 190 applies 64 bits of write data or a combination of 56 bits of write data and 8 mask bits to the I/O gating and mask logic circuit 144. These 64 bits are then written to memory cells in one of the banks of arrays 122a-h.

In reading data from and writing data to the SDRAM, it is important that the data be properly mapped so that memory addresses for read operations correspond to memory addresses for write operations. As shown in FIG. 5, the first 4 bits of write data are stored in the input registers 180a-d and the second 4 bits of write data are stored in the input registers 180e-h. Thus, the first 8 bits of write data output from the write FIFO and driver circuit 190 correspond to the first two 4-bit groups of write data. These two 4-bits groups of write data are stored in a location in one of the arrays 122a-h designated by a row address RA0-13 and a column address CA3-9 (the first three column address bits CA0-2 are used to control the multiplexer and select the input registers 180a-p). When the same row address RA0-13 and column address CA3-9 are used for a read operation, the 8 bits of data written to that address will be coupled to the read latch 148. Therefore, each row address RA0-13 and a column address CA3-9 will select the same memory cells in both a read operation and a write operation. As also shown in FIG. 5, when data are written to the SDRAM device 100 in a burst of sixteen 4-bit nibbles starting at an address, that same 64 bits of data are read from the SDRAM device 100 at that address in a burst of eight 8-bit bytes.

Returning to FIG. 4, the above-described operation of the SDRAM device 100 is controlled by control logic 200, which includes a command decoder 204 that receives command signals through a command bus 208. These high level command signals, which are typically generated by a memory controller, are a clock a chip select signal CS#, a write enable signal WE#, a column address strobe signal CAS#, and a row address strobe signal RAS#, with the “#” designating the signal as active low. Various combinations of these signals are registered as respective commands, such as a read command or a write command. The control logic 200 also receives a clock signal CLK and a clock enable signal CKE, which allow the SDRAM device 100 to operate in a synchronous manner. The control logic 200 generates a sequence of control signals responsive to the command signals to carry out the function (e.g., a read or a write) designated by each of the command signals. The control logic 200 also applies signals to the refresh counter 130 to control the operation of the refresh counter 130 during refresh of the memory cells in the arrays 122a-h. The control signals generated by the control logic 200, and the manner in which they accomplish their respective functions, are conventional. Therefore, in the interest of brevity, a further explanation of these control signals will be omitted. The control logic 200 also includes a mode register 210 that may be programmed by signals coupled through the command bus 208 during initialization of the SDRAM device 100. The mode register 210 then generates mode control signals that are used by the control logic 200 to control the operation of the SDRAM device 100 in various modes.

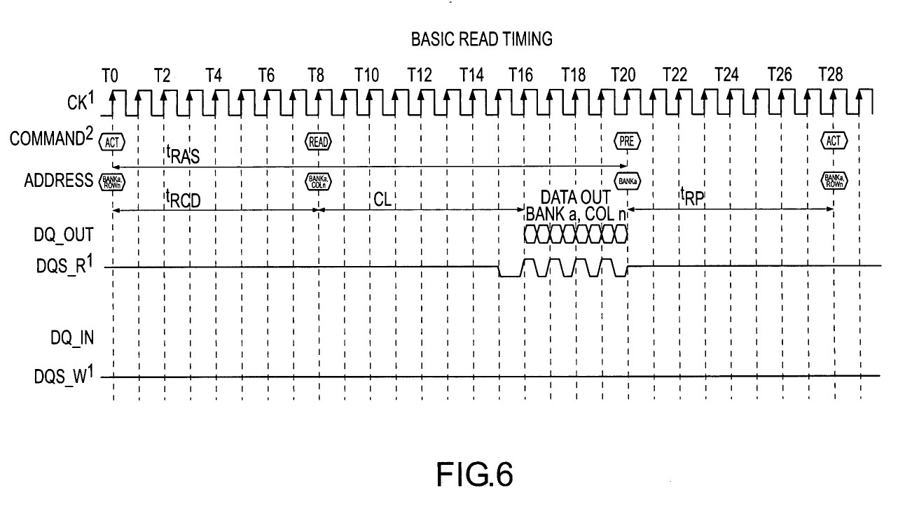

The operation of the SDRAM device 100 for a basic read operation is shown in FIG. 6. An activate command ACT is registered at time To (the times “T” are shown with the rising edges of the CK signal) along with a bank address “a” and row address “n.” As is well-known in the art, the ACT command causes row “n” in bank “a” to be activated so that the sense amplifiers 140a-h sense data stored in the memory cells in the row “n.” A read command READ and bank address “a” and column address “n” are registered at time T₈. The READ command is therefore directed to the same bank and row that was activated at time T₀. Therefore, a row address need not be provided at time T₈. At time T₁₅, the read data strobe signal DQS_R transitions low to provide a strobe preamble that is not synchronized to any read data bits. However, on the next eight transitions of the DQS_R signal between time T₁₆ and time T₂₀, 8 bits of read data are output from the SDRAM device 100 (although 8 bits of read data are output on each transition the read data strobe signal DQS_R, only one bit of read data is shown in FIG. 6 for purposes of clarity). The read data output from the SDRAM device 100 is responsive to the READ command that was registered at time T₈. Thus at time t₂₀, 64 bits of read data have been output from the SDRAM device 100 using the process explained above. A memory device that outputs read data on both the rising edge and the falling edge of a data strobe signal is known as a double data rate (“DDR”) memory device. A precharge command and a bank address “a” are registered at time T₂₀, which causes bank “a” of the memory cell arrays to be precharged.

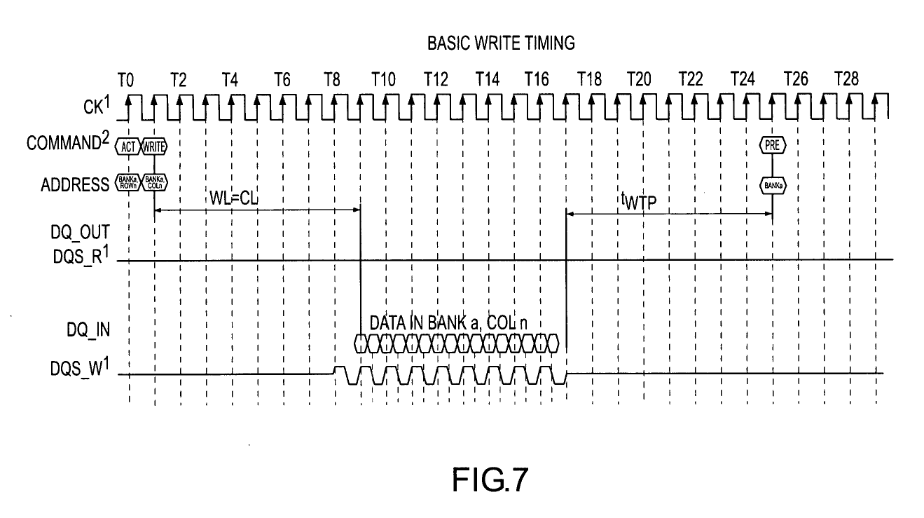

The operation of the SDRAM device 100 for a basic write operation is shown in FIG. 7. An activate command ACT is registered along with the address for bank “a” and row “n” at time T₀. The ACT command is immediately followed by a write command WRITE and bank address “a” and column address “n” at time T₁. In response to this WRITE command directed to column “n” of row “n” in bank “a,” the write data strobe signal DQS_W transitions high at time T₈ and then low to provide a strobe preamble that is not used to capture any write data bits. On each of the next sixteen transitions of the DQS_W signal between time T₉ and time T₁₇, 4 bits of write data are applied to the SDRAM device 100 (although 4 bits of write data are present on each transition write data strobe signal DQS_W, only one bit of write data is shown in FIG. 7 for purposes of clarity). Thus at time T₁₇, 64 bits of write data have been applied to the SDRAM device 100 and processed as explained above. A precharge command and a bank address “a” are again registered at time T₂₅, which causes the memory cells in the bank “a” to be precharged.

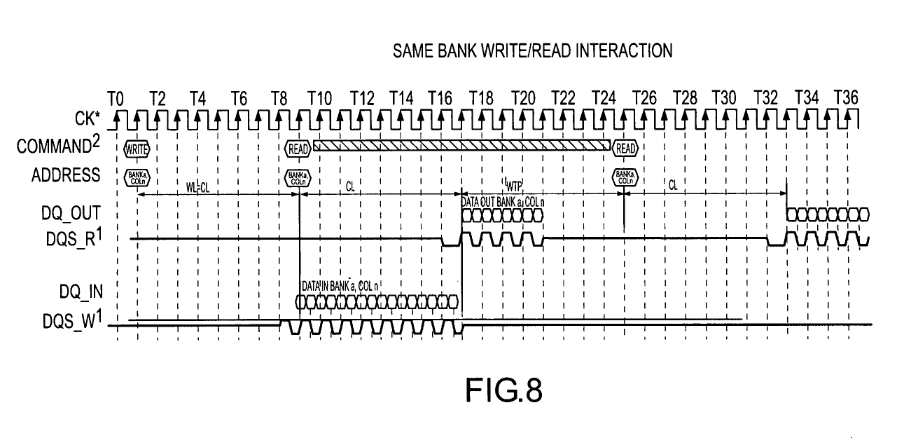

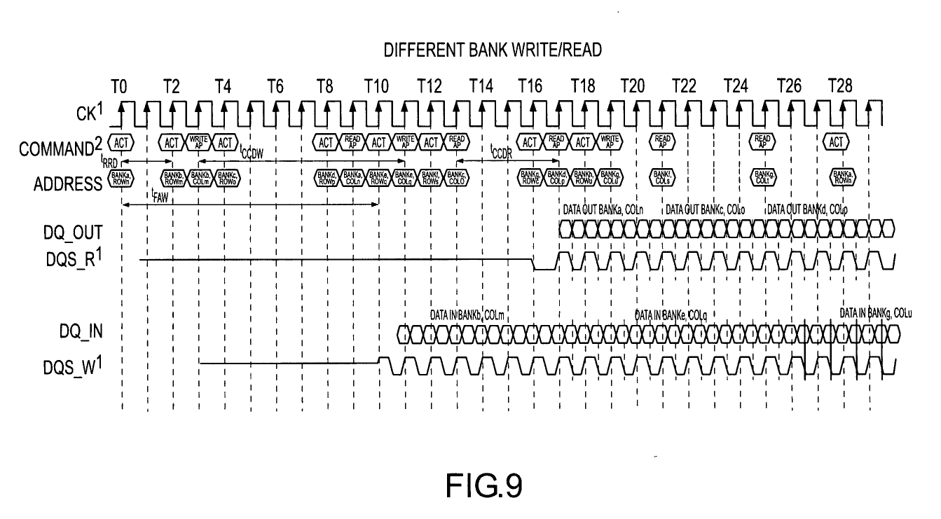

Another example of the operation of the SDRAM device 100 is shown in FIG. 8. The operation shown in FIG. 9 is for sequential writes and reads to the same bank of the memory cell arrays. A write command WRITE and a bank address “a” and column address “n” are registered at time T₁. It is assumed that a row in bank “a” has already been activated. At time T₈, a write data strobe preamble occurs followed by transitions of the write strobe signal starting at time T₉, which capture sixteen bits of write data from time T₉ until time T₁₇. A read command READ and an address that is also for bank “a” are registered at time T₉. The eight 8-bit bytes of read data resulting from the READ command are clocked onto the read data bus by transitions of the read data strobe signal DQS_R between time T₁₇ and time T₂₁. However, since the write data are still stored in the input registers at time T₁₇, the data that was previously stored in column “n” of the active row in bank “a” is output responsive to the READ command. A subsequent READ command directed to column “n” of bank “a” is registered at time T₂₅, and the data that was stored in column “n” of the active row in bank “a” responsive to the WRITE command are then read starting at time T₃₃.

The operation of the SDRAM device 100 for sequential writes and reads to the different banks of the memory cell arrays is shown in FIG. 9. The operation explained with reference to FIG. 9 exemplifies some of the advantages of using a write data that is separate from the read data bus. An ACT command and an address for row “n” of bank “a” are registered at time T₀, and an ACT command and an address for row “m” of bank “b” are registered at time T₂. At time T₃, a WRITE command directed to column “m” of row “m” in bank “b” is registered. This write is therefore directed to the row of memory cells that was activated at time T₂. Additional ACT commands directed to row “o” of bank “c” and row “p” of bank “d” are registered at times T₄ and T₈, respectively. At this point, 4 banks in the SDRAM device 100 are active.

At time T₉, a READ command and an address for column “n” of bank “a” are registered, which is the bank of memory cells that was activated at time T₀. Row “q” of bank “e” is then activated at time T₁₀. At time T₁₁, a WRITE command directed to column “q” of bank “e” is registered. Starting at time T₁₁, sixteen 4-bit nibbles of write data directed to row “q” of bank “e” starting in column “q” are applied to the SDRAM device 100. This write data corresponds to the WRITE command registered at time T₁₀. Another ACT command is registered along with an address for row “s” of bank “f” at time T₁₂ followed by a READ command directed to column “o” of bank “c” at time T₁₃. It was this bank “c” that was activated at time T₄. Still another ACT command for row “c” of bank “g” is registered at time T₁₆.

At time T₁₇, a READ command directed to column “p” in row “p” of bank “d,” which was activated at time T₈, is registered. At that same time T₁₇, data read from row “n” of bank “a” starting at column “n” are output from the SDRAM in a burst of eight bytes responsive to the READ command registered at time T₉. At time T₁₈, row “u” of bank “h” is activated. At time T₁₉, a WRITE command directed to row “c” of bank “g” starting at column “u” is registered. It will be recalled that this is the row and bank that was activated by the ACT command registered at time T₁₆. Also at time T₁₉, write data directed to row “c” of bank “g” starting in column “u” are applied to the SDRAM device 100. This write data corresponds to the WRITE command registered at time T₁₁. At time T₂₁, a READ command directed to row “s” of bank “f” starting at column “s” is registered, which is the row and bank that was activated responsive to the ACT command registered at time T₁₂. Still another READ command is registered at time T₂₅. This READ command is directed to row “c” of bank “g” starting at column “t,” which is the row and bank that was activated responsive to the ACT command registered at time T₁₆. Read data directed from row “p” of bank “d” starting in column “p” are output from the SDRAM device 100 starting at time T₂₅. This read data is responsive to the READ command that was registered at time T₁₇. At time T₂₇, write data directed to row “c” of bank “g” starting in column “u” are applied to the SDRAM device 100. This write data corresponds to the WRITE command registered at time T₁₉. By having a write data bus 170 (FIG. 4) that is separate from the read data bus 160, back-to-back write data may be applied to the SDRAM device 100, and back-to-back read data may be output from the SDRAM device 100. By making the width of the write data bus 170 different from the width of the read data bus 160, the data bandwidth of the SDRAM device 100 can be optimized based on the mix of read requests and write requests received by the SDRAM device 100 in any application.

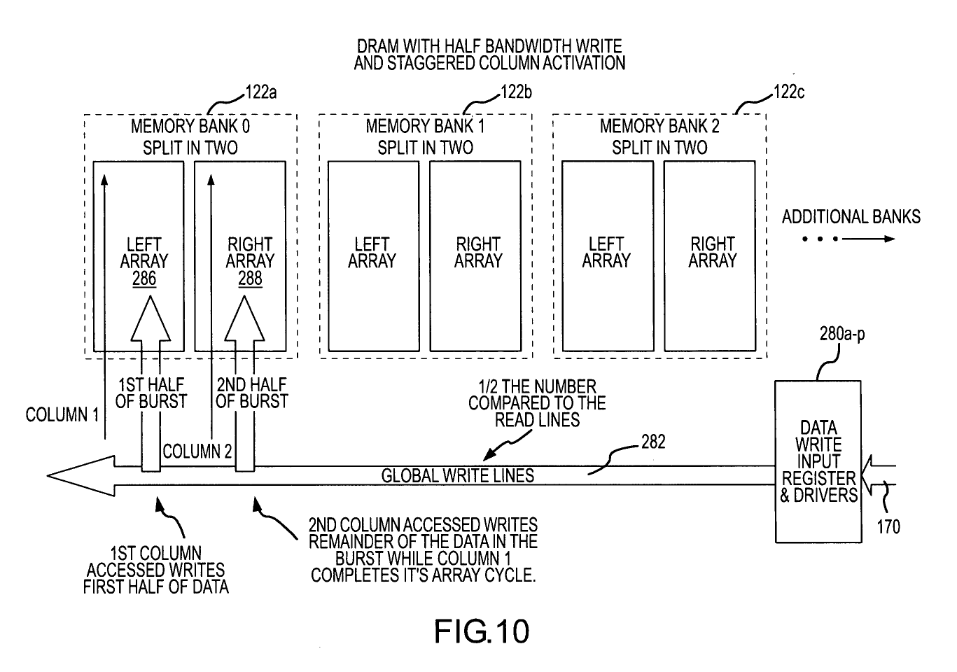

In the SDRAM device 100 of FIG. 4, the width of the write data path from the input registers 180a-p to the arrays 122a-h is the same width as the read data path. However, in alternative embodiments, the width of the write data path may be different from the width of the read data path. For example, as shown in FIG. 10, input registers 280a-p are coupled to the write data bus 170 to receive a burst of sixteen 4-bit nibbles. Eight global write lines 282 extend from the input registers 280a-h to a left array 286 and a right array 288 in each of the banks of memory cell arrays 122a-h. The 32 write data bits stored in the first eight input registers 280a-h are first coupled through the global write lines 282 to the left array 286 and stored in memory cells in the array 286. The 32 write data bits stored in the second eight input registers 280i-p are then coupled through the global write lines 282 to the right array 288 and stored in memory cells in the array 288. In alternative embodiments, only 8 input registers 280a-h are coupled to the write data bus to receive a burst of eight 4-bit nibbles. A first burst of 32 write data bits are stored in the input registers 280a-h and, when the registers 280a-h are full, are coupled through the global write lines 282 to the left array 286. A second burst of 32 write data bits are then stored in the input registers 280a-h and are coupled through the global write lines 282 to the right array 288.

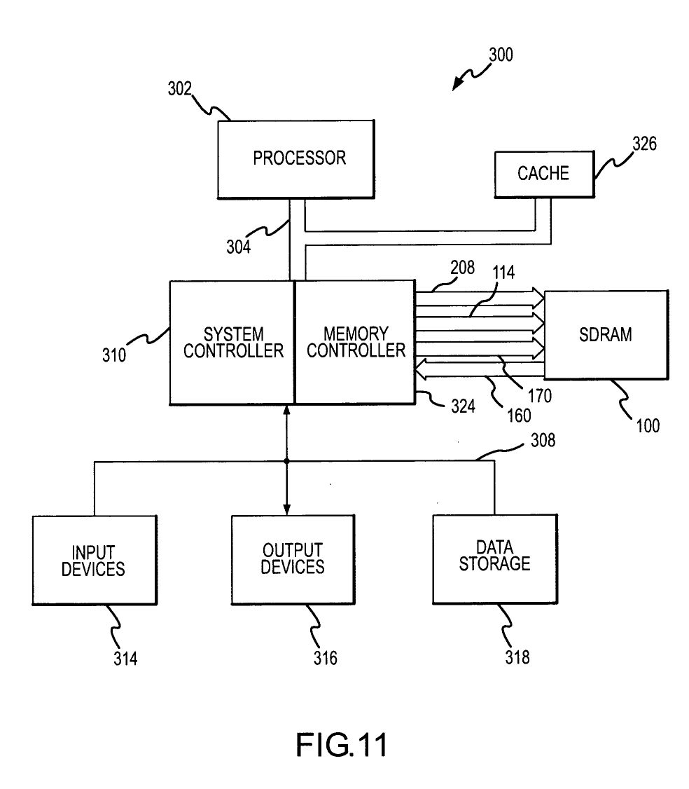

A computer system 300 using the SDRAM device 100 of FIG. 4 is shown in FIG. 11. The computer system 300 includes a processor 302 for performing various computing functions, such as executing specific software for performing specific calculations or tasks. The processor 302 includes a processor bus 304 that normally includes an address bus, a control bus, and a data bus. The processor bus is coupled to an expansion bus 308, such as a peripheral component interconnect (“PCI”) bus, through a system controller 310. The computer system 300 includes one or more input devices 314, such as a keyboard or a mouse, coupled to the processor 302 through the expansion bus 308, system controller 310 and processor bus 304 to allow an operator to interface with the computer system 300. Typically, the computer system 300 also includes one or more output devices 316 coupled to the expansion bus 308, such output devices typically being a printer or a video terminal. One or more mass data storage devices 318 are also typically coupled to the expansion bus 308 to store data or retrieve data from external storage media (not shown). Examples of typical mass data storage devices 318 include hard and floppy disks, tape cassettes, and compact disk read-only memories (CD-ROMs). The processor 302 is also typically coupled to a cache memory 326, which is usually static random access memory (“SRAM”). The system controller 310 also includes a memory controller 324, which is coupled to the SDRAM device 100 through the write data bus 170 and the read data bus 160 as well as the command bus 208 (which includes the read data strobe signals and the write data strobe signals) and the address bus 114.

From the foregoing it will be appreciated that, although specific embodiments of the invention have been described herein for purposes of illustration, it will be understood by one skilled in the art that various modifications may be made without deviating from the spirit and scope of the invention. Accordingly, the invention is not limited except as by the appended claims.

What is claimed is:

1. A memory device, comprising:
at least one bank of memory cells operable to store write data responsive to a write command and output read data responsive to a read command;
a plurality of write data terminals coupled to the at least one bank of memory cells; and
a plurality of read data terminals coupled to the at least one bank of memory cells and being isolated from the write data terminals, the number of write data terminals being different from the number of read data terminals.

2. The memory device of claim 1 wherein the memory device comprises a plurality of banks of memory cells, and wherein the memory device is operable to couple write data bits from the write data terminals to one of the banks of memory cells while read data bits are being coupled from another of the banks of memory cells.

3. The memory device of claim 1, further comprising input registers coupled to the write data terminals of the memory device, the input registers being operable to store a plurality of groups of write data bits sequentially received from the write data terminals and to simultaneously couple the write data bits stored in the input registers to the at least one bank of memory cells.

4. The memory device of claim 3, further comprising a write data strobe terminal receiving a write data strobe signal, and wherein the input receivers are operable to store each of the groups of write data bits responsive to the write data strobe signal.

5. The memory device of claim 3 wherein the memory device is operable to receive a column address, and wherein the input registers include control terminals operable to receive respective column address bits for controlling which of the input registers store a group of write data bits received from the write data terminals.

6. The memory device of claim 3 wherein the number of write data bits stored in the input registers and simultaneously coupled to the at least one bank of memory cells correspond in number to a number of read data bits coupled from the at least one bank of memory cells.

7. The memory device of claim 1, further comprising a read latch coupled to the at least one bank of memory cells, the read latch being operable to store a plurality of read data bits simultaneously received from the at least one bank of memory cells and to sequentially couple a plurality of groups of the read data bits stored in the read latch to the read data bus.

8. The memory device of claim 7 wherein the read latch includes a plurality of output buses through which respective groups of the read data bits stored in the read latch are coupled, and wherein the memory device further comprises a multiplexer having a plurality of input buses coupled to respective ones of the output buses of the read latch, the multiplexer further having an output bus coupled to the read data bus, the multiplexer being operable to select one of the groups of the read data bits for coupling to the read data bus.

9. The memory device of claim 8 wherein the memory device further comprises address terminals receiving respective column address bits, and wherein the multiplexer includes control terminals operable to receive respective ones of the column address bits for controlling which of the groups of the read data bits are coupled to the read data bus by the multiplexer.

10. The memory device of claim 7 wherein the memory device further comprises a read data strobe terminal outputting a read data strobe signal, and wherein the read latch is coupled to the read data bus through read data drivers, the read data drivers being operable to coupled respective ones of the read data bits received from the read latch to the read data bus in synchronism with the read data strobe signal.

11. The memory device of claim 1 wherein the memory device comprises a dynamic random access memory device.

12. The memory device of claim 10 wherein the memory device comprises a synchronous dynamic random access memory device.

13. The memory device of claim 1 wherein the number of read data terminals is twice the number of write data terminals.

14. A memory system, comprising:
a memory controller having a plurality of write data terminals and a plurality of read data terminals;
at least one memory device having a plurality of read data terminals and a plurality of write data terminals;
a write data bus having a plurality of conductors coupling the write data terminals of the memory controller to the write data terminals of the at least one memory device; and
a read data bus having a plurality of conductors coupling the read data terminals of the at least one memory device to the read data terminals of the memory controller, the read data bus being isolated from the write data bus and having a number of conductors that is different from the number of conductors in the write data bus.

15. The memory system of claim 14 wherein the at least one memory device comprises a plurality of banks of memory cells, and wherein the at least one memory device is operable to couple write data bits from the write data terminals to one of the banks of memory cells while read data bits are being coupled from another of the banks of memory cells.

16. The memory system of claim 14 wherein the at least one memory device further comprises an array of memory cells and input registers coupled to the write data terminals of the memory device, the input registers being operable to store a plurality of groups of write data bits sequentially received from the write data terminals and to simultaneously couple the write data bits stored in the input registers to the array of memory cells.

17. The memory system of claim 16, further comprising a write data strobe terminal receiving a write data strobe signal, and wherein the input receivers are operable to store each of the groups of write data bits responsive to the write data strobe signal.

18. The memory system of claim 16 wherein the memory controller is operable to couple a column address to the memory device, and wherein the input registers include control terminals operable to receive respective column address bits for controlling which of the input registers store a group of write data bits received from the write data terminals.

19. The memory system of claim 16 wherein the number of write data bits stored in the input registers and simultaneously coupled to the at least one bank of memory cells correspond in number to a number of read data bits coupled from the read data terminals.

20. The memory system of claim 14, further comprising a read latch coupled to the at least one array of memory cells, the read latch being operable to store a plurality of read data bits simultaneously received from the at least one array of memory cells and to sequentially couple a plurality of groups of the read data bits stored in the read latch to the read data bus.

21. The memory system of claim 20 wherein the read latch includes a plurality of output buses through which respective groups of the read data bits stored in the read latch are coupled, and wherein the at least one memory device further comprises a multiplexer having a plurality of input buses coupled to respective ones of the output buses of the read latch, the multiplexer further having an output bus coupled to the read data bus, the multiplexer being operable to select one of the groups of the read data bits for coupling to the read data bus.

22. The memory system of claim 21 wherein the memory controller is operable to couple a column address to the at least one memory device, and wherein the multiplexer includes control terminals operable to receive respective column address bits for controlling which of the groups of the read data bits are coupled to the read data bus by the multiplexer.

23. The memory system of claim 20 wherein the at least one memory device is operable to couple a read data strobe signal to the memory controller, and wherein the read latch is coupled to the read data bus through read data drivers, the read data drivers being operable to couple the read data bits received from the read latch to the read data bus in synchronism with the read data strobe signal.

24. The memory system of claim 14 wherein the memory controller is further operable to couple memory commands and row and column addresses to output terminals of the memory controller, the memory commands and row and column addresses being coupled to the memory device through an output bus.

25. The memory system of claim 24 wherein the output bus comprises a command bus and an address bus.

26. The memory system of claim 14 wherein the at least one memory device comprises a dynamic random access memory device.

27. The memory system of claim 26 wherein the memory controller is further operable to couple a clock signal to the memory device, and wherein the at least one memory device comprises a synchronous dynamic random access memory device and includes a clock input terminal, the memory system further comprising a clock signal line coupling the clock signal from the memory controller to the clock input of the memory device.

28. The memory system of claim 14 wherein the number of read data terminals is twice the number of write data terminals.

29. A processor-based system, comprising:
a processor having a processor bus;
an input device coupled to the processor through the processor bus to allow data to be entered into the computer system;
an output device coupled to the processor through the processor bus to allow data to be output from the computer system;
a mass data storage device coupled to the processor through the processor bus to allow data to be read from the mass storage device;
a memory controller coupled to the processor through the processor bus, the memory controller having a plurality of write data terminals and a plurality of read data terminals;
at least one memory device having a plurality of read data terminals and a plurality of write data terminals;
a write data bus having a plurality of conductors coupling the write data terminals of the memory controller to the write data terminals of the memory device; and
a read data bus having a plurality of conductors coupling the read data terminals of the memory device to the read data terminals of the memory controller, the read data bus being isolated from the write data bus and having a number of conductors that is different from the number of conductors in the write data bus.

30. The processor-based system of claim 29 wherein the at least one memory device comprises a plurality of banks of memory cells, and wherein the at least one memory device is operable to couple write data bits from the write data terminals to one of the banks of memory cells while read data bits are being coupled from another of the banks of memory cells.

31. The processor-based system of claim 29 wherein the at least one memory device further comprises an array of memory cells and input registers coupled to the write data terminals of the memory device, the input registers being operable to store a plurality of groups of write data bits sequentially received from the write data terminals and to simultaneously couple the write data bits stored in the input registers to the array of memory cells.

32. The processor-based system of claim 31, further comprising a write data strobe terminal receiving a write data strobe signal, and wherein the input receivers are operable to store each of the groups of write data bits responsive to the write data strobe signal.

33. The processor-based system of claim 31 wherein the memory controller is operable to couple a column address to the memory device, and wherein the input registers include control terminals operable to receive respective column address bits for controlling which of the input registers store a group of write data bits received from the write data terminals.

34. The processor-based system of claim 31 wherein the number of write data bits stored in the input registers and simultaneously coupled to the at least one bank of memory cells correspond in number to a number of read data bits coupled from the read data terminals.

35. The processor-based system of claim 29, further comprising a read latch coupled to the at least one array of memory cells, the read latch being operable to store a plurality of read data bits simultaneously received from the at least one array of memory cells and to sequentially couple a plurality of groups of the read data bits stored in the read latch to the read data bus.

36. The processor-based system of claim 35 wherein the read latch includes a plurality of output buses through which respective groups of the read data bits stored in the read latch are coupled, and wherein the at least one memory device further comprises a multiplexer having a plurality of input buses coupled to respective ones of the output buses of the read latch, the multiplexer further having an output bus coupled to the read data bus, the multiplexer being operable to select one of the groups of the read data bits for coupling to the read data bus.

37. The processor-based system of claim 36 wherein the memory controller is operable to couple a column address to the at least one memory device, and wherein the multiplexer includes control terminals operable to receive respective column address bits for controlling which of the groups of the read data bits are coupled to the read data bus by the multiplexer.

38. The processor-based system of claim 35 wherein the at least one memory device is operable to couple a read data strobe signal to the memory controller, and wherein the read latch is coupled to the read data bus through read data drivers, the read data drivers being operable to couple the read data bits received from the read latch to the read data bus in synchronism with the read data strobe signal.

39. The processor-based system of claim 29 wherein the memory controller is further operable to couple memory commands and row and column addresses to output terminals of the memory controller, the memory commands and row and column addresses being coupled to the memory device through an output bus.

40. The processor-based system of claim 39 wherein the output bus comprises a command bus and an address bus.

41. The processor-based system of claim 29 wherein the at least one memory device comprises a dynamic random access memory device.

42. The processor-based system of claim 41 wherein the memory controller is further operable to couple a clock signal to the at least one memory device, and wherein the memory device comprises a synchronous dynamic random access memory device and includes a clock input terminal, the memory system further comprising a clock signal line coupling the clock signal from the memory controller to the clock input of the memory device.

43. The processor-based system of claim 29 wherein the number of read data terminals is twice the number of write data terminals.

44. A method of coupling data between a memory controller and a memory device, comprising:
simultaneously coupling M bits of write data from the memory controller to the memory device; and
simultaneously coupling N bits of read data from the memory device to the memory controller, the value of M being different from the value of N.

45. The method of claim 44 wherein the value of N is twice the value of M.

46. The method of claim 44 wherein the write data are coupled from the memory controller to the memory device in a write burst of X, and wherein the read data are coupled from the memory device to the memory controller in a read burst of Y, where X*M is equal to Y*N.

47. The method of claim 44 wherein the acts of simultaneously coupling M bits of write data from the memory controller and simultaneously coupling N bits of read data from the memory device comprises coupling M bits of write data from the memory controller at the same time that N bits of read data are being coupled from the memory device.

48. A method of writing data to a memory device and reading data from a memory device, the memory device having a write data bus and a read data bus separate from the write data bus, the method comprising coupling write data bits to the write data bus at the same time that read data bits are being coupled from the read data bus, the number of write data bits being coupled to the write data bus being different from the number of read data bits being coupled from the read data bus.

49. The method of claim 48 wherein the acts of coupling write data bits to the write data bus and coupling read data bits from the read data bus comprises coupling twice as many read data bits from the read data bus as the number of write data bits being coupled to the write data bus.

50. The method of claim 48 wherein the acts of coupling write data bits to the write data bus and coupling read data bits from the read data bus comprises coupling the write data bits to the write data bus in a write data burst and coupling read data bits from the read data bus in a read data burst.

51. A method of writing data to a memory device and reading data from a memory device, the memory device having a write data bus and a read data bus, the read data bus being separate from the write data bus and having a width that is different from the width of the write data bus, the method comprising:
receiving a plurality of groups of write data bits through the write data bus, the write data bits in each group being simultaneously applied to the write data bus;
accumulating the write data bits applied to the write data bus from a plurality of groups until a first plurality of write data bits have been accumulated;
when the first plurality of write data bits have been accumulated, transferring the first plurality of write data bits to an array of memory cells in the memory device;
accumulating a second plurality of read data bits coupled from the array of memory cells; and
dividing the accumulated read data bits into a plurality of groups and sequentially transferring the groups of read data bits to the read data bus.

52. The method of claim 51 wherein the number of write data bits in the first plurality is equal to the number of read data bits in the second plurality.

53. The method of claim 51 wherein the act of dividing the accumulated read data bits into a plurality of groups comprises using a plurality of bits of a column address to select the accumulated read data bits in each group.

54. The method of claim 51, further comprising receiving a write data strobe signal at the memory device, and wherein the act of accumulating the write data bits applied to the write data bus comprises capturing the write data bits responsive to the write data strobe signal.

55. The method of claim 51, further comprising transferring a read data strobe signal from the memory device, and wherein the act of sequentially transferring the groups of read data bits to the read data bus comprises sequentially transferring the groups of read data bits to the read data bus in synchronism with the read data strobe signal.
